(19) United States
(12) Patent Application Publication
(10) Pub. No.: US 2007/0094104 A1
(43) Pub. Date: Apr. 26, 2007

(54) Internet method and computer product for preparing state income tax withholding forms

(76) Inventor: Thomas M Reahard, Scottsdale, AZ (US)

Correspondence Address: ETHERTON LAW GROUP, LLC, 5555 E. VAN BUREN STREET, SUITE 100, PHOENIX, AZ, 85008, US

(21) Appl. No.: 11/637,462

(22) Filed: Dec. 11, 2006

Related U.S. Application Data
(63) Continuation-in-part of application No. 10/910,930, filed on Aug. 3, 2004.
(60) Provisional application No. 60/503,352, filed on Sep. 15, 2003.
(60) Provisional application No. 60/749,943, filed on Dec. 12, 2005.

(51) Int. Cl. G06Q 10/00

(52) U.S. Cl. 705/28

(57) ABSTRACT

An automated method and computer product for processing employee state income tax exemption certificates. The system includes a method for determining the required state exemption forms, if any, as well as a method for completing and submitting the forms. An employee logs-on to a state forms website on a remote server. The state forms website prompts the user for certain data and determines which exemption forms need to be filed for that employee, depending on the employee's residence, work states, the employer's nexus with the employee's resident state, and the states' exemption reciprocity with other states. The required withholding forms to be completed are preferably pre-filled with the employee's information, and the employee makes his changes or additions and signs the transaction electronically. The resultant updated data is stored.

### CROSS-REFERENCE TO RELATED APPLICATIONS

This application claims the benefit of co-pending U.S. provisional application Ser. No. 60/749,943 filed Dec. 12, 2005 and is a continuation-in-part of co-pending U.S. patent application Ser. No. 10/910,930 filed Aug. 3, 2004, which claims benefit of U.S. provisional application Ser. No. 60/503,352 filed Sep. 15, 2003, all of which are incorporated herein by reference.

### FIELD OF INVENTION

This invention relates generally to data processing. This invention relates particularly to implementing a method and apparatus on remote servers, particularly across the internet, for determining, completing, transmitting and storing state income tax withholding forms.

### BACKGROUND

The federal government requires federal income tax to be withheld from every employee's paycheck, with some limited exceptions. The amount to be withheld is calculated form using unique data provided by each employee on a W-4, including the number of exemptions the employee wants to claim. The W-4 form is therefore also known as an employee exemption certificate. Computerized systems are available, both online and offline, that assist the employee in preparing the W-4 form. The W-4 forms are submitted, either on paper or electronically, to the employer and in some cases to the Internal Revenue Service. A new W-4 form must be generated each time an employee's tax status changes, and in many companies the human resources department requires employees to complete new exemption certificates at the start of each new year.

Similarly, most states and territories require that state income tax be withheld, but some states do not. For those states that require state withholding, each has a different method of determining how much is withheld. Some states require the use of a specific state form, some accept the federal W-4 form, and at least one does not require a form. For the states that require the use of a form, some states require that the form be submitted for all employees, but other states require the form to be submitted only when certain exemptions are claimed. Complications arise when an employee resides in one state, but works in another state. Some states have reciprocity agreements with other states such that, if payroll taxes are withheld in one state, the employee is exempted from paying state taxes in the other state. However, that determination can depend on whether the employer has nexus with the state the employee lives in. Like the federal system, the proper new forms must be generated each time an employee's tax status changes. It would be desirable to have a computerized system that determines which state forms are needed, taking into account the appropriate factors.

Historically this work has been done manually, with human resource and payroll departments collecting each employee's information, collating the data, making calculations, and submitting the appropriate forms. For employers with many employees across many states, the administrative burden is very high.

To complicate matters further, federal and state tax laws are constantly changing, thereby affecting the amounts to be withheld and the forms to be used. The withholding information must be stored and, for electronic information, retrievable in the format of the year the data was applied, in the event of an audit. It is important to use the latest calculations and forms, and to be able to retrieve stored data in the desired format years after the associated tax laws have changed.

Because withholding affects the amount of take-home pay, employees are keenly interested in knowing the exact amount that will be withheld. Many events can change an employee's tax status, and most of those are life-changing, such as marriage (or divorce), birth of a child, promotion, or relocation to a new state. This adds to the administrative burden on the employer. It would be desirable to provide a system that enables the employee to determine the withheld amounts and to change his or her exemptions, without the aid of the employer. Such a system must also be designed with security and privacy in mind. In sum, it would be desirable to have a single, automated system to manage electronic filing of all of the various state exemption certificates.

Until the advent of the system described in the above-referenced patent application Ser. No. 10/910,930, no computerized system was available for the preparation of multiple states' forms, or even for the determination of whether a state form was needed. That application described a system that is preferably wholly-contained within an employer's computer system, so as to maximize security and privacy with such sensitive data as the employer's social security number and other payroll information. Surprisingly, however, it has become apparent that employers would prefer to have the tax exemptions and calculations performed on a host's computer system, on a remote computer external to the employer's computer system, despite the potential of increased risk to security and privacy. Fortunately, methods for security and privacy have improved in the meantime. Therefore, the present invention describes a method for tax form preparation done in large part on remote servers, particularly across the internet.

### SUMMARY OF THE INVENTION

The present invention is an automated method and computer product for processing employee state tax income exemption certificates. The system includes a method for determining the required state exemption forms, if any, as well as a method for completing and submitting the forms. An employee logs-on to a state forms website on a remote server and is authenticated by his employer's intranet website or employee self service portal. The state forms website determines which exemption forms need to be filed for each employee, depending on the employee's residence, work states, the employer's nexus with the employee's resident state, and the states' exemption reciprocity with other states. The state forms website prompts the user for certain data and, using the employee-entered data, guides the employee to the federal, state or local form to be completed. To complete the forms, a data feed from the employer database on the employer's server passes employee data to remote servers where the state forms website resides. The withholding forms are thus pre-filled with the employee's information, and the employee makes his changes or additions and signs the transaction electronically.

The resultant updated data is transmitted to the employer for historical storage and for updating its payroll system and, optionally, to the taxing authority. Alternatively, the completed forms can be relayed to the employer's servers via secured email from the remote servers. The data for the completed forms is stored on the employer's servers or on the remote servers, and can be retrieved from storage and printed for audit purposes at a later date.

### BRIEF DESCRIPTION OF THE DRAWINGS

FIG. 1 is a simplified schematic diagram of a system according to one embodiment of the present invention.

FIG. 2 shows the generic version of the state selection page.

FIG. 3 is a screen shot of the state selection page accessed from a browser, customized for Kaiser Permanente.

FIG. 4 is a screen shot of the form selection page accessed from a browser, customized for Kaiser Permanente.

FIG. 5 is the instruction page accessed from a browser.

FIG. 6 is Federal Form W-4 accessed from a browser.

FIG. 7 is Arizona state form A-4 accessed from a browser.

FIG. 8 is the first page of California Form DE-4 accessed from a browser.

### DETAILED DESCRIPTION OF THE INVENTION

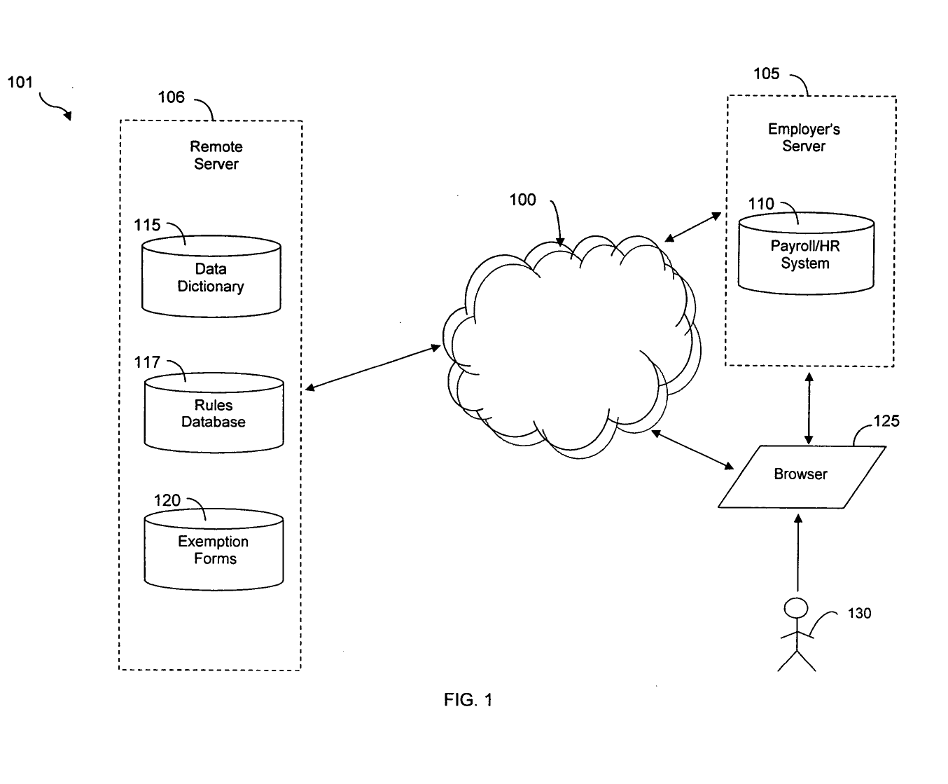

The present invention includes an automated method for determining an employee's required state exemption forms, if any, as well as a method for completing and submitting the forms. Referring to FIG. 1, there is illustrated a simplified schematic diagram of the system 101 of the present invention. An employer's server 105 includes a system 110 containing payroll data, human resources data, or both (referred to herein as payroll/HR system 110). One or more remote servers includes a data dictionary 115 and electronic federal, state, and local employee exemption certificate forms 120. As used herein, state forms includes local forms, too. Also as used herein, remote server 106 refers to a single server as well plurality of remote servers. The system 101 of the invention also includes a browser 125, which is preferably operated by an employee 130, but may be operated by a human resources representative or other agent. Data from several sources including the employee 130, the payroll/HR system 110 and the data dictionary 115 are used to populate a selected exemption form 120 on the browser 125 according to a method as described below. The servers communicate across a network, preferably the internet 100.

To use the system, an employee logs-on to an internet website for state withholding forms that is hosted on the remote server 106. This website is referred to herein as the state forms website. Preferably the state forms website is accessible through the employer's computer system and the employee is authenticated by the employer's computer system. Alternatively, the state forms website is accessible from outside the employer's computer system by a publicly-accessible URL. In such case, the employee may be authenticated by other methods, including user identifier and password or other verification information passed from the employer's computer system, as known in the art. Preferably the website is customized for each employer with the employer's brand identifiers. This serves to confirm to the employee that he is on the correct site, further develop brand identity, and reinforce that this is a benefit provided by the employer.

The state forms website utilizes a method for determining which federal or state forms are to be completed. The automated determination method determines which exemption forms need to be filed for each employee, depending on the employee's residence, work state or states, the employer's nexus with the employee's resident state, and the states' exemption reciprocity with other states. The determination method can be a stand-alone component or it can also be a part of a integrated system in which not only are the forms determined, but completed and submitted.

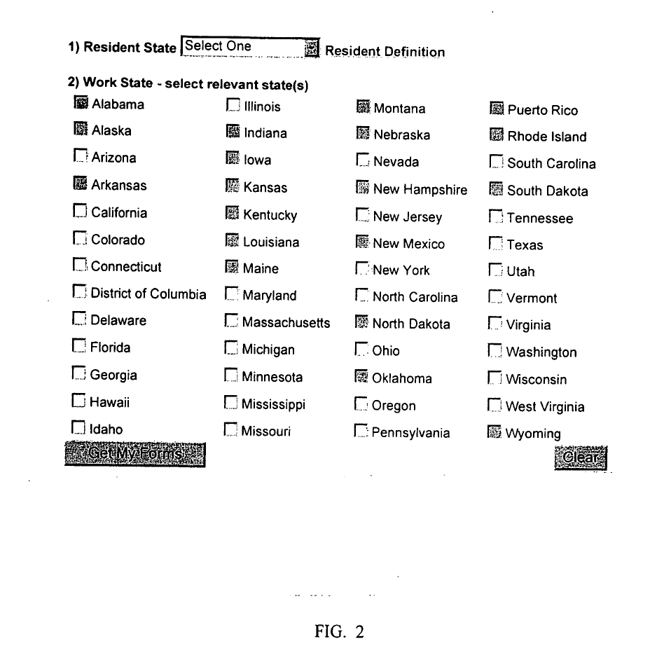

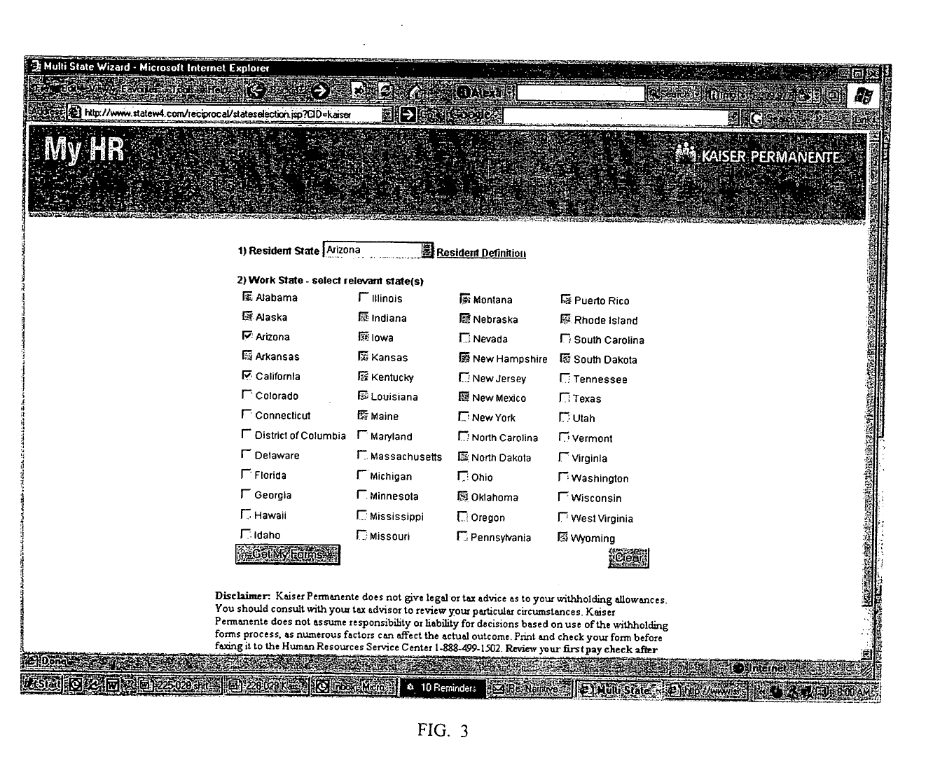

Specifically, to determine which exemption forms are to be completed, the state forms website presents a state selection page. FIG. 2 shows the generic version of the state selection page. The employee selects the appropriate state of residence and selects states that he works in. The state of residence and work states are referred to herein as geographic work data. Selection can be made by a drop down menu, pointing and clicking on a state in a map, toggling radio buttons or checkboxes, or other selection methods known in the art. FIG. 3 shows a screen shot of the state selection page using checkboxes that has been customized for Kaiser Permanente with Arizona selected as the resident state and Arizona and California selected as the work states.

The employer's nexus and states' reciprocity information is provided in a rules database 117 in communication with the state selection website. Alternatively, rules can be represented in an embedded format such as XML. The criteria that define residency, nexus with the state, and exemption reciprocity between states are known to persons skilled in payroll tax issues. Typically a person of such skill will be familiar with a few state's regulations, but not all. Advantageously, however, the rules database 117 associated with the state selection website includes data from all tax jurisdictions in the United States. The data is provided by a number of sources, primarily the employer and state and local laws, rules, regulations and Judicial interpretations. For example, under Arizona statute ARS 43-104, a person is a resident of Arizona for payroll tax purposes if he is domiciled or spends in the aggregate more than nine months of the taxable year the state, unless he is there for a temporary or transitory purpose. The data changes constantly and is preferably updated as the changes are made, but no less than annually.

To make the determination, the geographic work data is compared to information in the rules database 117. To make the determination, the rules database is searched for a reciprocal agreement between the resident state and the work state. If such a relation ship exists, then any nonresident forms for the work state are displayed as well as the forms for the resident state and nonresident state. If no reciprocal agreement exists, then all the work state forms are displayed. In addition, if nexus exists between the employer and the resident state, then the resident state forms are also displayed.

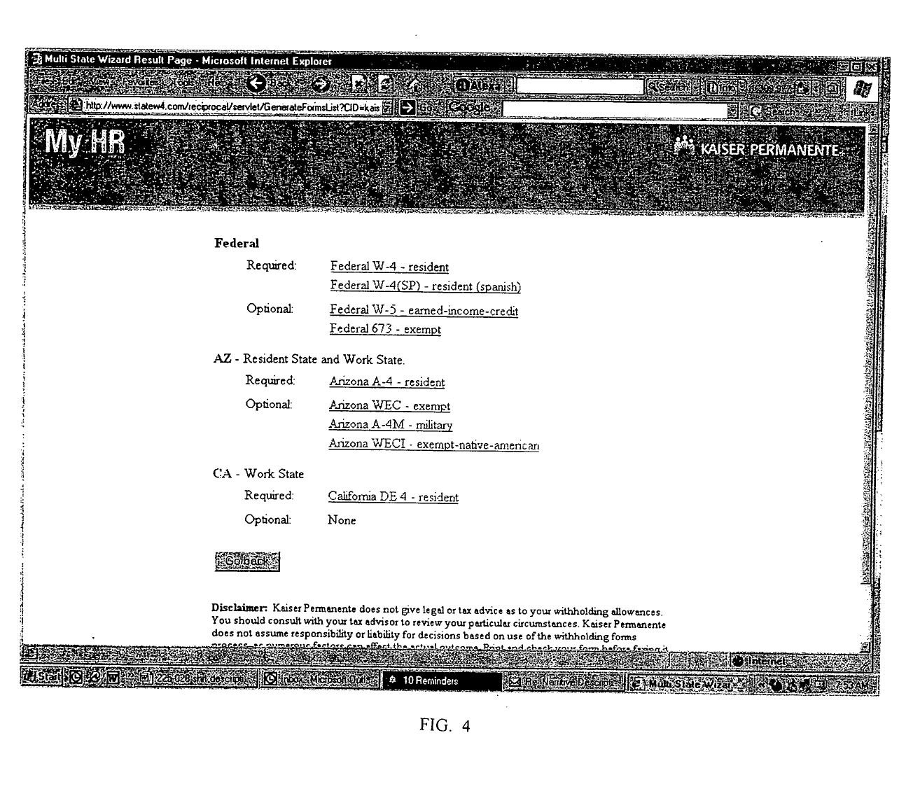

Once the required state exemption forms, if any, are determined, a list of all the required exemption forms is displayed in the browser. Optional forms may also be displayed. See FIG. 4. In a preferred embodiment, each form in the list is hyperlinked to the form (or facsimile thereof) that is stored with the exemption forms 120 on the remote server 106. The data dictionary 115 includes fields from one or more of the employee information, employer information, tax parameter information, and control information categories. The payroll tax exemption forms 120, data dictionary 115 and rules database 117 may reside on the same server, be integral, or be distributed across a number of servers. Generally the data dictionary 115 and rules database 117 are referred to herein as the remote database.

The employee clicks on the link to access the form. The form is displayed by implementing certain information found in the data dictionary 115. The data dictionary 115 contains all necessary data to display and complete the process of filling out any payroll tax exemption form 120 for any state tax jurisdiction. The data dictionary 115 is a carefully constructed set of data fields that can be applied across all the exemption forms, although some of the data fields may not be used in a given state's form. In one embodiment of the present invention, all of the data necessary to populate a particular state's exemption certificate form 120 is included at the browser 125 in the form of hidden fields. The hidden fields have their visible attribute set to false, meaning that the employee 130 will not see any of these fields. If the value of a hidden field needs to be displayed, the form 120 will copy the values from the hidden fields into temporary visible fields that are visible to the employee 130. Thus, if a state does not require data from a certain hidden field, no visible field will appear on the browser 125 for the employee 130 to fill in and the data in that hidden field will not be used to populate that particular state form.

The employee 130 selects a desired form from those listed on the form selection page. Some of the fields may be pre-populated using known employee or company data including, for example, employee name and the number of tax exemptions claimed from the previous year. This employee data is fed from the employer's payroll/HR system 110 to the remote server 106, preferably using an XML data feed. Preferably the data is encrypted and transmitted using the Secure Sockets Layer (SSL) protocol. Alternative formats may be used for providing this data. Other fields are pre-populated using data from the data dictionary 115. The data dictionary 115 preferably provides information from four categories: employee information, organization information, tax parameters, and control data. Each is discussed below.

Employee Information

The employee information contains all the personal data associated with an employee. Examples include:
Employee.uniqueIdentifier
Employee.employeeID
Employee.firstName
Employee.middleInitial
Employee.lastName
Employee.socialSecurityNumber
Employee.streetAddress1
Employee.streetAddress2
Employee.city
Employee.state
Employee.ZIP
Employee.driversLicenseNumber
Employee.dateOfHire

Organization Information.

The organization information contains information specific to the employer such as name, address, and contact individual. The name “organization” is used herein alternately with “employer”. Examples include:
Organization.name
Organization.streetAddress1
Organization.streetAddress2
Organization.city
Organization.state
Organization.ZIP
Organization.federalEIN
Organization.stateEIN
Organization.contactPerson

Tax Parameter Information

The Tax Parameter category contains the information necessary to properly withhold taxes from an employee paycheck. Although several of the parameters are the same in many of the states, a preferred embodiment of the present invention provides each state with its own set of tax parameters to avoid any confusion.
Examples include:
TaxParameter.exemptFromStateWithholding
TaxParameter.additionalStateWithholding
TaxParameter.mustFileWithState
Filing Status
Total Allowances
Filing Status is also known in the art as the marital status.

Control Information

The control information contains control fields that are used to control and maintain information about the form itself and to control the submission process.

Examples include:
Control.date
Control.dateTime
Control.formNumber
Control.formVersion
Control.stateFormName
Control.stateName
Control.formType
Control.fieldFillColor
Control.fieldBorderColor
Control.printOnly
Control.preserveInputFieldValue
Control.previewMode
Control.validateBeforePrint
Control.forceSocialSecurityNumber
Control.eSignatureMessage
Control.eSignatureResponse
Control.signatureLine
Control.serverURL

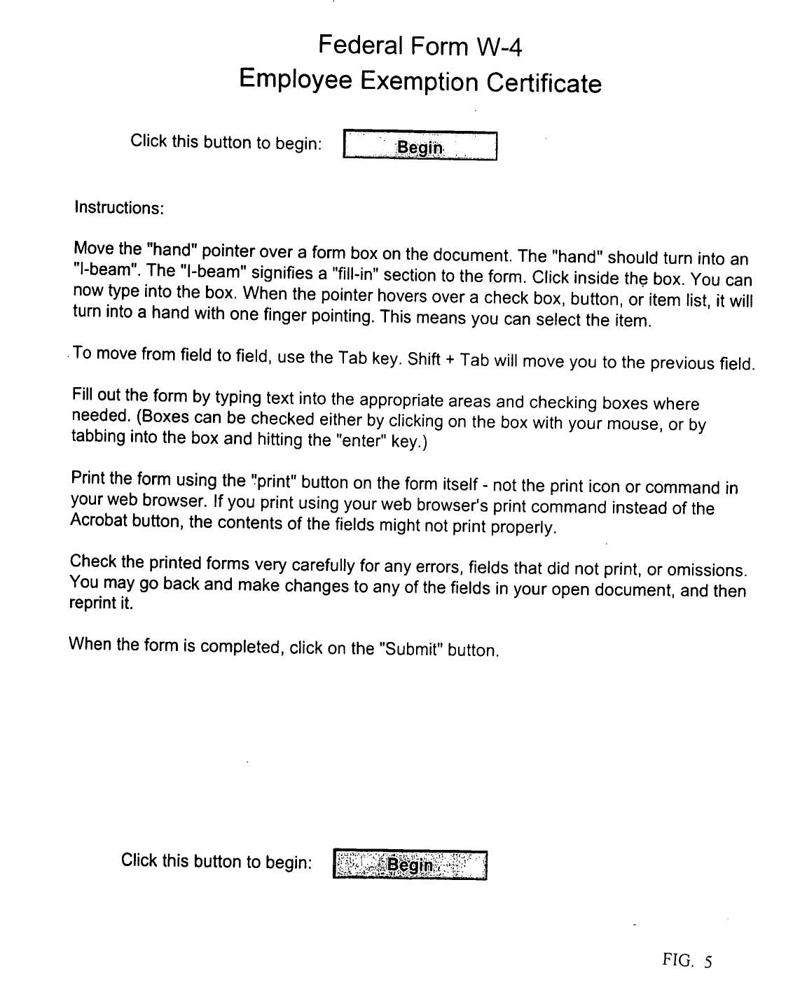

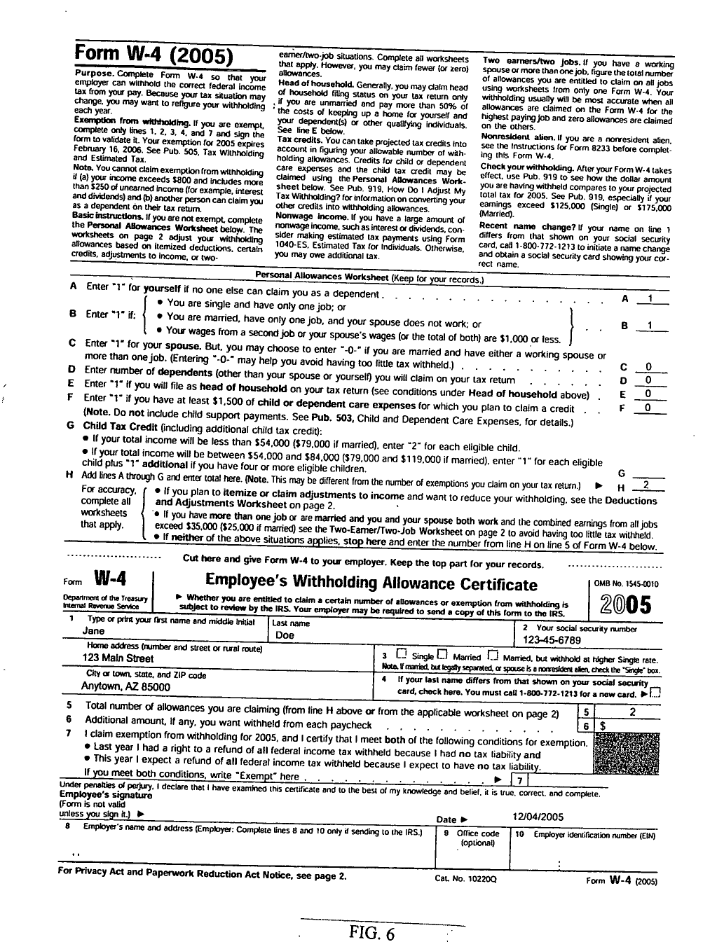

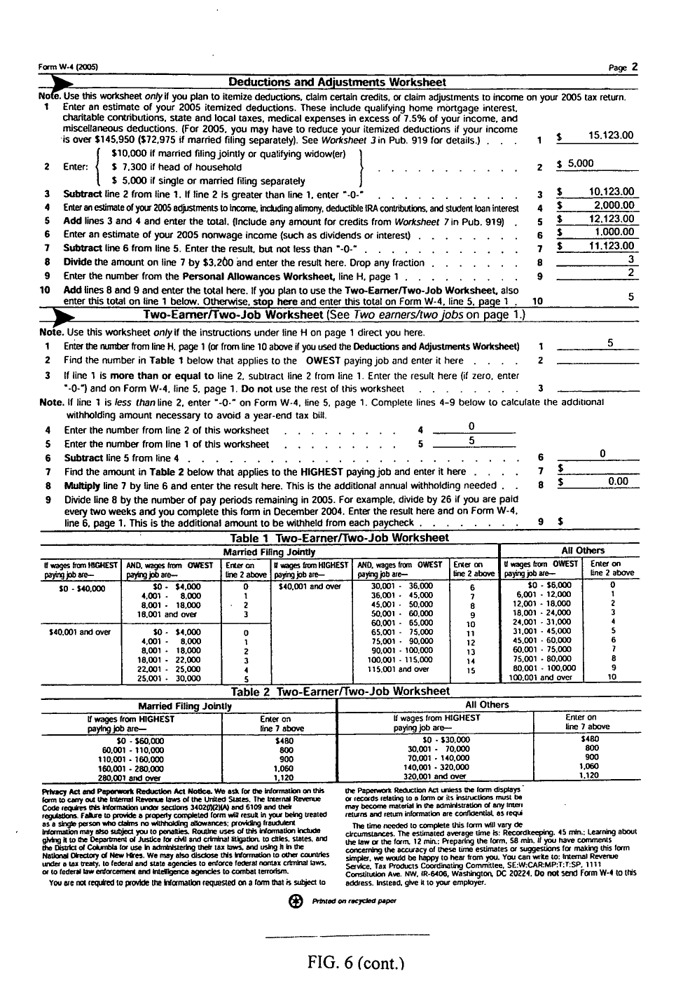

The forms are presented to the employee 130 in the browser 125, preferably in a fillable format, such as fillable PDF. For example, if the employee 130 selects the form named Federal W-4, that form will appear in the employee's browser, preferably in a fillable format. FIG. 6 shows a federal W-4 form with example data entered from employee Jane Doe. An instruction page may also be presented to the employee. See FIG. 5. The employee then reviews the pre-populated form and adds or changes data as necessary. According to one embodiment of the present invention, each entry is validated to make sure it is filled in and that the correct type of information is in the field. Further, entries may be validated to ensure mandatory information is included and does not conflict with other entered data. For example, a form will not be processed if an employee selects withholding allowances and also marks that he is exempt from withholding. Where necessary, certain calculations are also made to fill required fields. For example, a state may ask for the number of exemptions, then ask the employee 130 to subtract two to determine the final number of exemptions allowed. This calculation of subtracting two may be automatically carried out in the browser 125.

The form may be printed and submitted in paper form to the employer, which then may be required submit the form to the taxing jurisdiction. In the preferred embodiment, however, the employee 130 signs the form electronically and submits the updated employee exemption certificate form 120 to the remote server 106. The updated form is received at the remote server 106, data are extracted and stored on the remote server 106 or the employer's server 105.

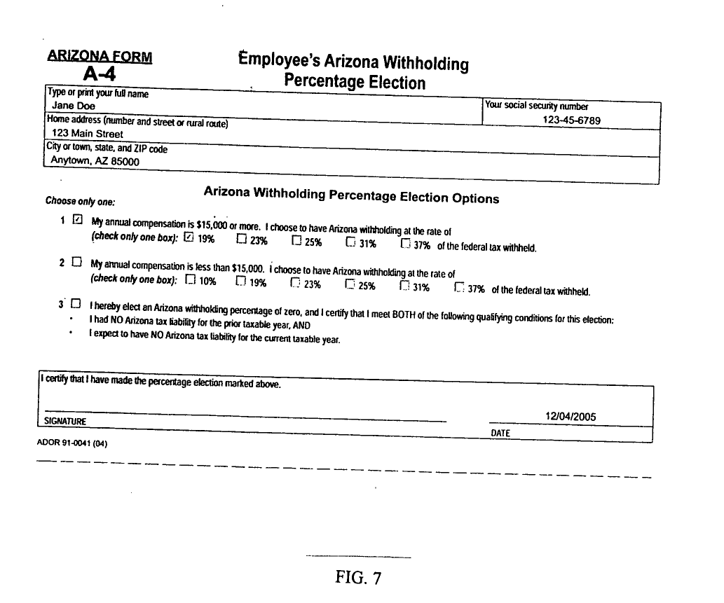

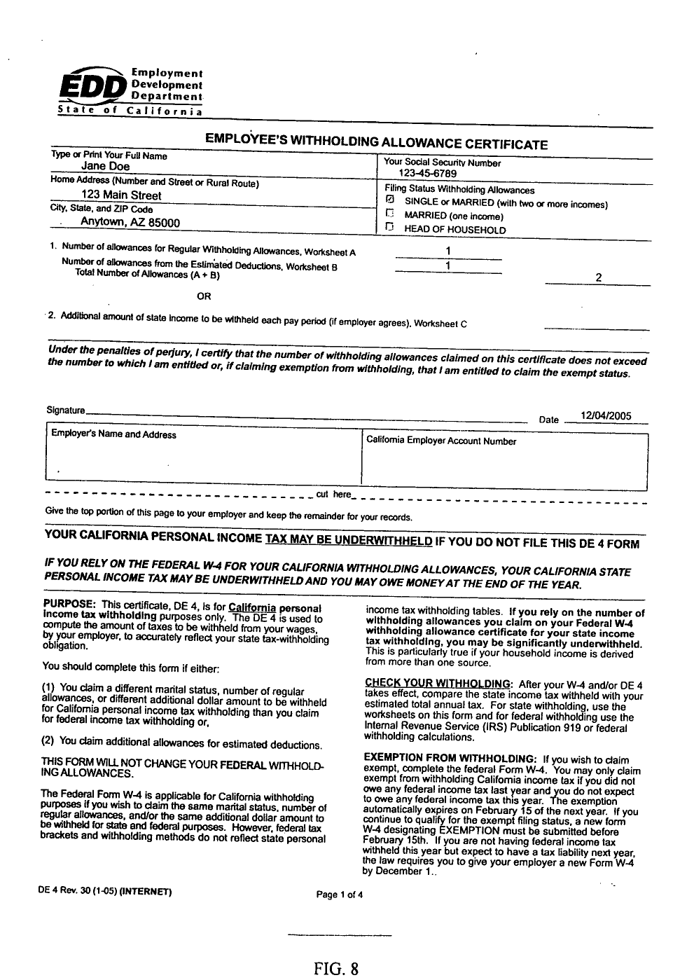

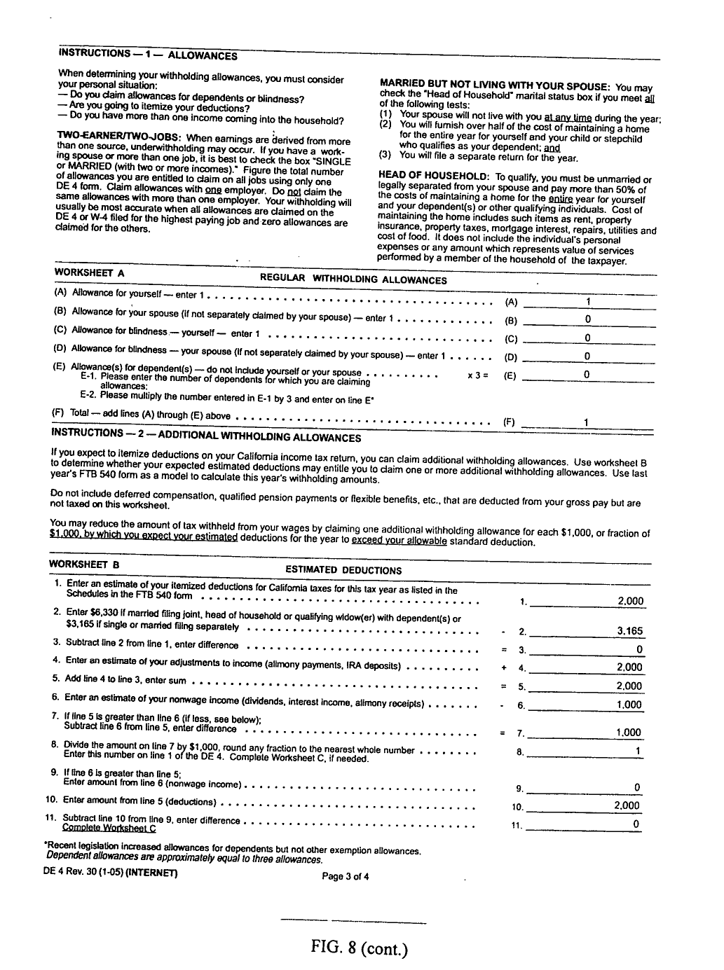

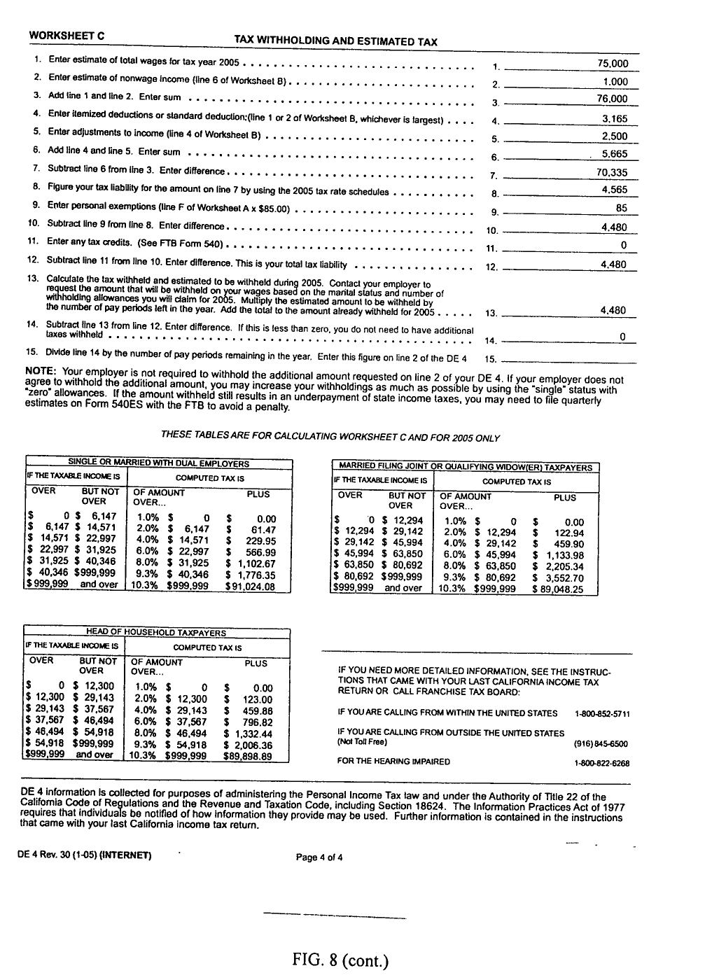

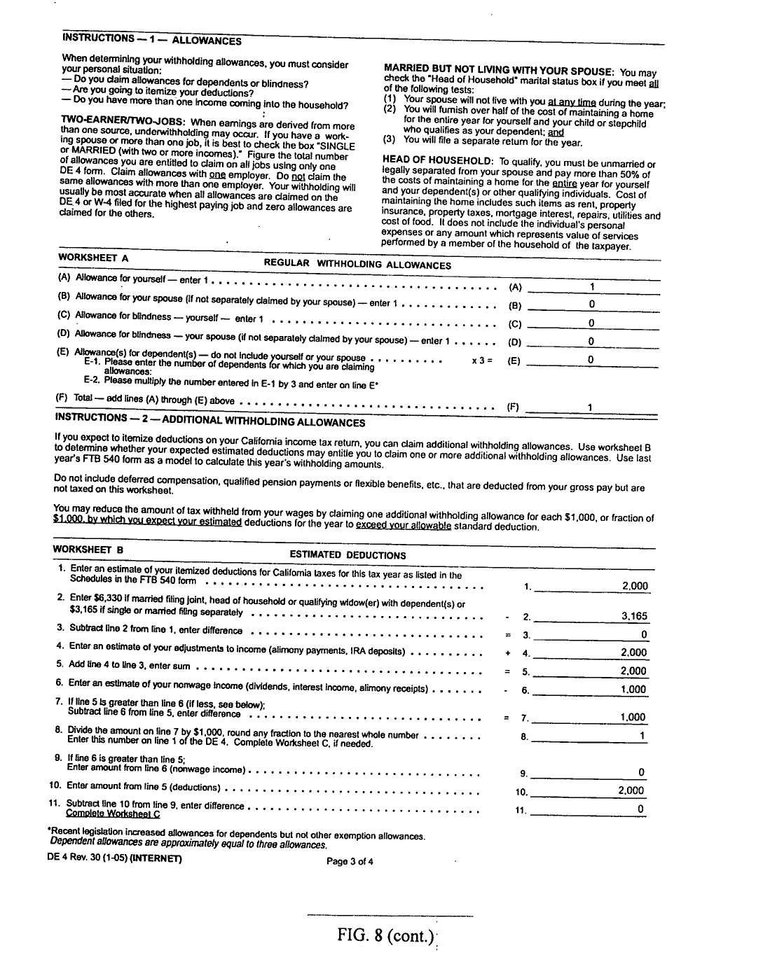

The employee may return to the forms selection page and select another form to complete and submit in a manner similar to that explained above. FIG. 7 shows an Arizona state exemption form A-4 form with example data entered from employee Jane Doe. FIG. 8 shows a California state exemption form DE-4 form with example data entered from employee Jane Doe. Again, the employee then reviews the pre-populated form and adds or changes data as necessary. The employee 130 signs the form electronically and submits the updated employee exemption certificate form 120 to the remote server 106. The updated form(s) is received at the remote server 106, data are extracted and stored on the remote server 106, at least until transmitted to the employer.

The employee data and form data are transmitted to the employer for updating its payroll/HR system 110 and historical storage, preferably on employer server 105. Preferably the data is in a format that minimizes the amount of data transmitted, transmission time, and storage space. Forms can be recreated for audit purposes from this stored data. Optionally, the completed forms can be relayed via email from the remote server 106 and can be retrieved from storage and printed for audit purposes at a later date. Optionally, the completed forms (or just the data therefor) can be submitted to the taxing authority. Regardless of method of transmission, the data is transmitted in a secure fashion preferably using Secure Sockets Layer (SSL) protocol. Alternatively, the data may be stored on the remote server 106.

Those skilled in the art will recognize that various data processing methods may be used to collect, transmit and store data entered into the forms 120. For example, to minimize data storage requirements, data posted from a form 120 is preferably in a string and usually smaller than 5 k in size. Various file formats such as Forms Data Format (FDF) files or XML formatted documents may be used when transmitting form data between the remote server 106 and the browser 125. Individual data elements may be extracted from the string using known software routines.

While there has been illustrated and described what is at present considered to be a preferred embodiment of the present invention, it will be understood by those skilled in the art that various changes and modifications may be made, and equivalents and future technologies may be substituted for elements thereof without departing from the true scope of the invention. Therefore, it is intended that this invention not be limited to the particular embodiment disclosed as the best mode contemplated for carrying out the invention, but that the invention will include all embodiments falling within the scope of the appended claims.

I claim:

1. A method in a computer system for preparing an employee exemption certificate form, the method comprising:
a) determining with the computer system whether one or more employee exemption certificate forms is required;
b) if an employee exemption certificate form is required, completing a first form for a first state by entering information into the computer system; and
c) transmitting the entered infomration to a remote server via the internet.

2. A method of claim 1 further comprising:
d) storing information for more than one state in a remote database on a remote server;
e) providing geographic work data to the computer system to determine whether the one or more employee exemption certificate form is required; and
f) transmitting the geographic work data and entered information to a remote server via the internet.

3. The method of claim 1 further comprising completing a second form for a second state by entering additional information into the computer system.

4. The method of claim 2 wherein the remote database includes employee information, organization information, and tax parameters.

5. The method of claim 2 wherein the remote database includes criteria for more than one state which define residency, nexus with other states, and exemption reciprocity.

6. A method in a computer system for preparing an employee exemption certificate form, the method comprising:
a) determining with the computer system whether one or more employee exemption certificate forms is required, the determination further comprising:
i. entering into the computer system geographic work data including an employee's state of residence and one or more states the employee works in;
ii. comparing the geographic work data to information stored in a remote database on a remote server, wherein the remote database comprises information for more than one state;
b) if one or more employee exemption certificate forms is required, displaying a list thereof.

7. The method of claim 6 wherein the determining further comprises transmitting payroll/HR data from an employer's server to the remote server via the internet.

8. The method of claim 6 further comprising transmitting the geographic work data via the internet to the remote server.

9. The method of claim 6 wherein the remote database includes employee information, organization information, and tax parameters.

10. The method of claim 6 wherein the remote database includes criteria for more than one state which define residency, nexus with other states, and exemption reciprocity.

11. A method in a computer system for completing an employee exemption certificate form, the method comprising:
a) using a browser to access a website that is in communication with a remote server, wherein the remote server includes information for more than one state;
b) determining whether one or more employee exemption certificate forms is required;
c) if one or more employee exemption certificate forms is required, displaying a list of the forms in the browser;
d) completing a first employee exemption certificate form from a first state by entering employee information in the browser;
e) transmitting the employee information to the remote server via the internet; and
f) storing the employee information at the remote server.

12. The method of claim 11 in which the determining further comprises:
i. entering geographic work data in the browser, the geographic work data including an employee's state of residence and one or more states the employee works in; and
ii. transmitting the geographic work data to the remote server; and
iii. comparing the geographic work data to the information in the remote server.

13. The method of claim 11 wherein transmitting the employee information to the remote server further comprises:
i. transmitting the employee exemption certificate form into which the employee information was entered to the remote server via the internet; and
ii. extracting the employee information from the employee exemption certificate form; and
iii. storing the extracted information on the remote server.

14. A computer program product for processing employee exemption certificate forms, the product comprising computer readable program code devices for:
a) determining whether one or more employee exemption certificate forms is required;
b) completing a first form for a first state; and
c) transmitting the completed form to a remote server via the internet.

15. The product of claim 14 further comprising a computer readable program code device for completing a second form for a second state.

16. The product of claim 14 further comprising computer readable program code devices for:
d) storing information for more than one state in a remote database on the remote server;
e) providing geographic work data to determine whether an employee exemption certificate form is required; and
f) if an employee exemption certificate form is required, completing the form by providing additional information from the remote database.

17. The product of claim 14 further comprising computer readable program code devices for:
d) displaying a browser;
e) listing the required employee exemption certificate forms in the browser; and
f) wherein competing a first from further comprises entering employee data into the browser.

18. The product of claim 14 wherein determining further comprises computer readable program code devices for:
d) providing geographic work data to the browser; and
e) providing payroll/HR data from the employer's server via the internet.

19. The product of claim 16 wherein the information in the remote database includes employee information, organization information, and tax parameters.

20. The product of claim 16 wherein the remote database includes criteria for more than one state which define residency, nexus with the state, and exemption reciprocity.
